(19) United States
(12) Patent Application Publication
(10) Pub. No.: US 2026/0300362 A1
(43) Pub. Date: Oct. 1, 2026

(54) CONTENT DISPLAY METHOD AND APPARATUS, READABLE MEDIUM, ELECTRONIC DEVICE, AND PROGRAM PRODUCT

(71) Applicant: Beijing Youzhuju Network Technology Co., Ltd., Beijing (CN)

(72) Inventors: Jiaqian Zhang, Beijing (CN); Jin Bai, Beijing (CN)

(21) Appl. No.: 19/634,389

(22) Filed: Mar. 31, 2026

(30) Foreign Application Priority Data
Mar. 31, 2025 (CN) 202510400522.9

(51) Int. Cl. G06F 16/338; G06Q 30/0241

(52) U.S. Cl. CPC G06F 16/338; G06Q 30/0277

(57) ABSTRACT

Provided are a content display method and apparatus, a readable medium, an electronic device and a program product. The method includes: displaying a search page; and in response to a search operation for weather information in the search page, displaying target weather information and an interactive component, where the interactive component is used for displaying promotional information and/or accessing a landing page associated with the promotional information, and a display style of the interactive component is different when the target weather information is different.

### CROSS-REFERENCE TO RELATED APPLICATIONS

This application claims priority to Chinese Application No. 202510400522.9 filed Mar. 31, 2025, the disclosure of which is incorporated herein by reference in its entirety.

### TECHNICAL FIELD

The present disclosure relates to the field of computer technologies, and specifically, to a content display method and apparatus, a readable medium, an electronic device, and a program product.

### BACKGROUND

With the development of computer technologies, search engines have become one of the important ways for people to obtain information. For example, in a short video application, a weather search may be performed through a search engine to obtain weather information.

### SUMMARY

The Summary section is provided in order to introduce concepts in a brief form, and these concepts are described in detail in the following Detailed Description section. The Summary section is not intended to identify key features or essential features of the claimed technical solution, nor is it intended to limit the scope of the claimed technical solution.

In a first aspect, the present disclosure provides a content display method, including:

displaying a search page, where the search page is used for a user to perform information search; and

displaying target weather information and an interactive component in response to a search operation for weather information in the search page, where the interactive component is used for displaying promotional information and/or accessing a landing page associated with the promotional information, and a display style of the interactive component is different when the target weather information is different.

In a second aspect, the present disclosure provides a content display apparatus, including:

a first display module, configured to display a search page, where the search page is used for a user to perform information search; and

a second display module, configured to display target weather information and an interactive component in response to a search operation for weather information in the search page, where the interactive component is used for displaying promotional information and/or accessing a landing page associated with the promotional information, and a display style of the interactive component is different when the target weather information is different.

In a third aspect, the present disclosure provides a computer-readable medium having a computer program stored thereon, where the steps of the method according to the first aspect are implemented when the computer program is executed by a processing apparatus.

In a fourth aspect, the present disclosure provides an electronic device, including:

a storage apparatus having a computer program stored thereon; and

a processing apparatus, configured to execute the computer program in the storage apparatus to implement the steps of the method according to the first aspect.

In a fifth aspect, the present disclosure provides a computer program product including a computer program, where the steps of the method according to the first aspect are implemented when the computer program is executed by a processor.

With the above technical solution, the target weather information and the interactive component may be displayed when the weather information search is performed on the search page.

Other features and advantages of the present disclosure will be described in detail in the following Detailed Description section.

### BRIEF DESCRIPTION OF THE DRAWINGS

The above and other features, advantages, and aspects of the embodiments of the present disclosure will become more apparent when taken in conjunction with the drawings and with reference to the following Detailed Description. Throughout the drawings, the same or similar reference numbers refer to the same or similar elements. It should be understood that the drawings are schematic, and that the components and elements are not necessarily drawn to scale. In the drawings:

FIG. 1 is a schematic diagram of search results of a weather information search in the related art;

FIG. 2 is a flowchart of a content display method according to an exemplary embodiment of the present disclosure;

FIG. 3 is a schematic diagram of a display style of an interactive component according to an exemplary embodiment of the present disclosure;

FIG. 4 is a schematic diagram of a display style of an interactive component according to an exemplary embodiment of the present disclosure;

FIG. 5 is a schematic diagram of a display style of an interactive component according to an exemplary embodiment of the present disclosure;

FIG. 6 is a schematic diagram of a display style of an interactive component according to an exemplary embodiment of the present disclosure;

FIG. 7 is a schematic diagram of a display style of an interactive component according to an exemplary embodiment of the present disclosure;

FIG. 8 is a schematic diagram of a display style of an interactive component according to an exemplary embodiment of the present disclosure;

FIG. 9 is a flowchart of another content display method according to an exemplary embodiment of the present disclosure;

FIG. 10 is a block diagram of a content display apparatus according to an exemplary embodiment of the present disclosure; and

FIG. 11 is a schematic structural diagram of an electronic device according to an exemplary embodiment of the present disclosure.

### DETAILED DESCRIPTION OF EMBODIMENTS

The embodiments of the present disclosure are described in more detail below with reference to the drawings. Although some embodiments of the present disclosure are shown in the drawings, it should be understood that the present disclosure may be implemented in various forms, and should not be construed as being limited to the embodiments set forth herein; on the contrary, these embodiments are provided for a more thorough and complete understanding of the present disclosure. It should be understood that the drawings and embodiments of the present disclosure are only for exemplary purposes, and are not intended to limit the protection scope of the present disclosure.

It should be understood that the various steps described in the method implementations of the present disclosure may be performed in different orders, and/or performed in parallel. In addition, the method implementations may include additional steps and/or omit the execution of the steps shown. The scope of the present disclosure is not limited in this regard.

The term "include/comprise" and variations thereof used herein are open-ended inclusions, that is, "include/comprise but not limited to". The term "based on" is "at least partially based on". The term "one embodiment" means "at least one embodiment"; the term "another embodiment" means "at least one other embodiment"; the term "some embodiments" means "at least some embodiments". Relevant definitions of other terms will be given in the following description.

It should be noted that the concepts such as "first" and "second" mentioned in the present disclosure are only used to distinguish different apparatuses, modules or units, and are not used to limit the order of functions performed by these apparatuses, modules or units, or interdependence therebetween.

It should be noted that the modifications of "one" and "multiple" mentioned in the present disclosure are schematic rather than restrictive, and those skilled in the art should understand that unless otherwise clearly indicated in the context, they should be understood as "one or multiple".

The names of messages or information exchanged between multiple apparatuses in the implementations of the present disclosure are only used for illustrative purposes, and are not used to limit the scope of these messages or information.

It may be understood that before using the technical solutions disclosed in the embodiments of the present disclosure, the user should be informed of the type, range of use, use scenarios, etc. of personal information involved in the present disclosure in an appropriate manner and the authorization of the user should be obtained in accordance with relevant laws and regulations.

For example, in response to receiving an active request from a user, prompt information is sent to the user to clearly prompt the user that the requested operation will require access to and use of the user's personal information. In this way, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, and the prompt information may be presented in the pop-up window in text. In addition, the pop-up window may also include a selection control for the user to select "agree" or "disagree" to provide the personal information to the electronic device.

It may be understood that the above process of notifying and obtaining user authorization is only illustrative, and does not limit the implementations of the present disclosure. Other manners that satisfy relevant laws and regulations may also be applied to the implementations of the present disclosure.

At the same time, it may be understood that the data involved in the technical solution (including but not limited to the data itself, acquisition or use of the data) should comply with requirements of corresponding laws, regulations and related provisions.

As mentioned in the Background section, in the related art, when a weather search is performed through a search engine, there are problems such as a lack of diversity in the search results.

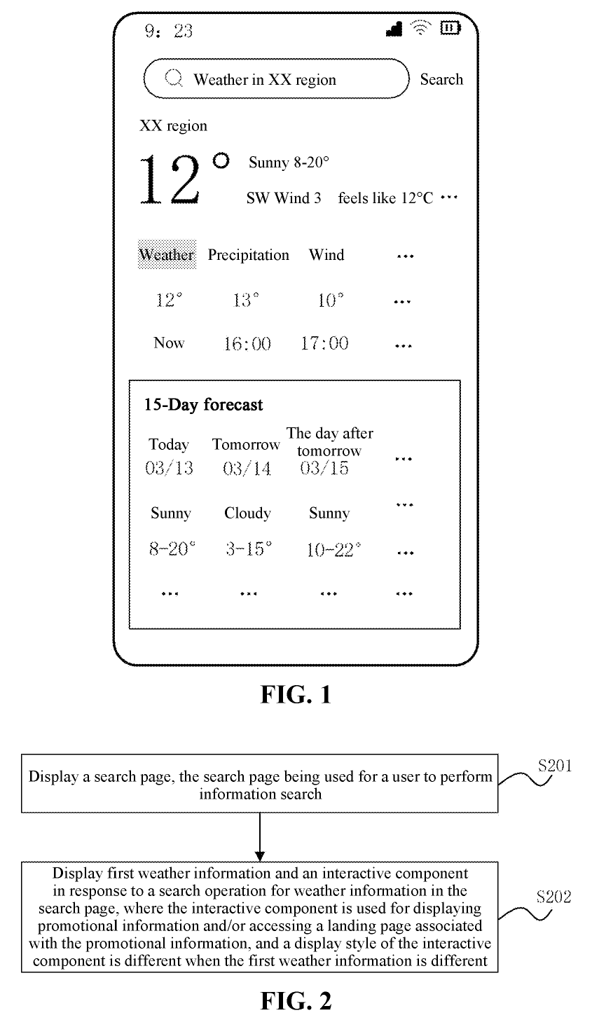

Exemplarily, in a short video application, a search control may be provided for a user to perform information search, and when the user searches for weather information through the search control, the weather information may be displayed on a display page of the short video application, as shown in FIG. 1. However, it may be seen according to FIG. 1 that the display page of the short video application generally only displays the weather information, and there are problems such as a lack of diversity in the search results.

In view of this, the present disclosure provides a content display method and apparatus, a readable medium, an electronic device, and a program product to solve the above technical problems.

The embodiments of the present disclosure are further explained below in conjunction with the drawings.

FIG. 2 is a flowchart of a method according to an exemplary embodiment of the present disclosure. Referring to FIG. 2, the method may include the following steps:

S201: a search page is displayed, where the search page is used for a user to perform information search.

In this embodiment, the search page may be a search page in a search-type application, may be a search page in a short video application, and may also be a search page in other applications, which is not limited in the embodiments of the present disclosure.

Exemplarily, the search page may be the search page in the short video application. Accordingly, when the user opens the short video application, a video playback page may be displayed, and a search control may be displayed in the upper right of the video playback page. When the user triggers the search control through an operation such as clicking, the search page may be displayed, and a search input box may be displayed in the search page. Accordingly, the user may perform information search by inputting a target search term in the search input box.

S202: target weather information and an interactive component are displayed in response to a search operation for weather information in the search page, where the interactive component is used for displaying promotional information and/or accessing a landing page associated with the promotional information, and a display style of the interactive component is different when the target weather information is different.

In this embodiment, the search operation for the weather information may be performed by voice input. For example, a voice input control may be displayed on the search page, and by triggering the voice input control, the user may search for the weather information by voice. The search may also be performed by text input. For example, a text input control may be displayed on the search page, and by triggering the text input control, the user may search for the weather information by text. Certainly, the search may also be performed by other means, which is not limited in the embodiments of the present disclosure.

It should be understood that the weather information may generally include a weather type and/or a weather level, etc., and different weather types and/or weather levels often bring different feelings to people. For example, sunny days usually bring people a bright and happy feeling, while cloudy days or rainy days may make people feel depressed or quiet. Therefore, in order to make the display style of the interactive component more in line with the current weather information and/or user feelings, different weather types and/or weather levels may correspond to different interactive component styles, so that the display style of the interactive component visually echoes the weather information, thereby improving the user experience. That is to say, in a possible implementation, when the target weather information corresponds to different weather types and/or weather levels, the display style of the interactive component may be different.

In this embodiment, the weather type may include sunny, cloudy, overcast, rainy, snowy, etc., and the weather level may include a rainfall level (such as light rain, moderate rain, and heavy rain, etc.) and a snowfall level (such as light snow, moderate snow, and heavy snow, etc.), etc.

In this embodiment, the different display styles of the interactive component may mean different display appearances of the interactive component, such as different display colors, different display effects, and/or different display shapes, etc., and may also mean different promotional information in the interactive component, such as different promotion objects, different promotional copy, or different display styles of the promotional information, etc., and may certainly be other differences, for example, both the display appearance of the interactive component and the promotional information in the interactive component are different, which is not limited in the embodiments of the present disclosure.

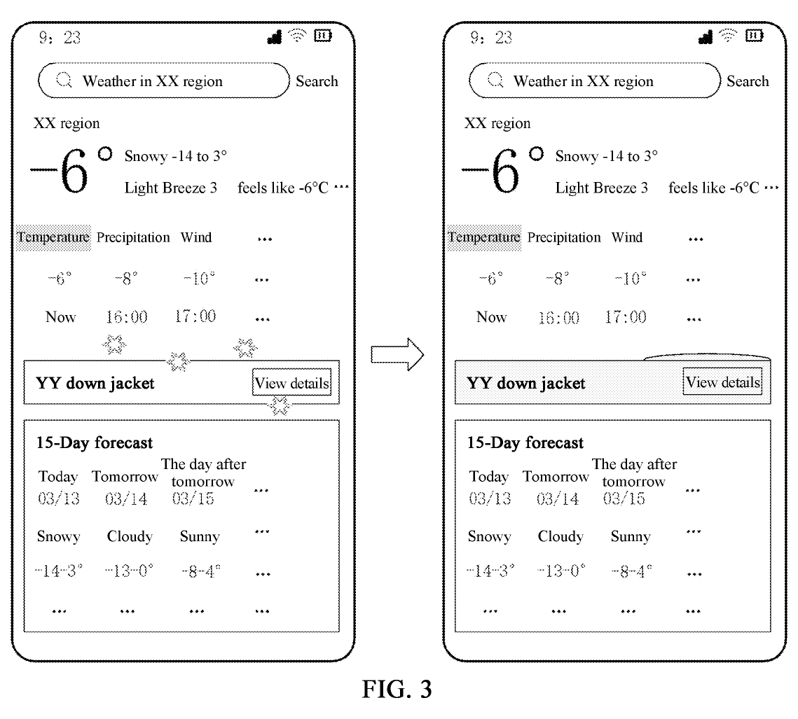

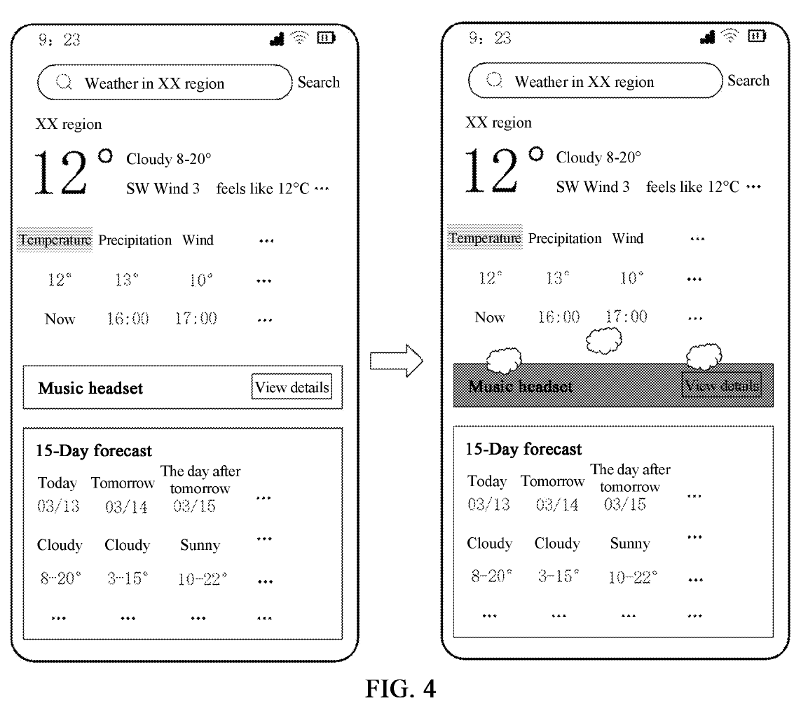

Exemplarily, still referring to the above example, when the target search term is "weather in XX region", the weather information about "XX region" and the interactive component may be displayed. If the weather type of "XX region" is snowy, on the one hand, the display color of the interactive component may be changed from an initial display color to a color in a cold tone, for example, to blue, and on the other hand, an effect may be displayed in the interactive component and/or at a preset position around the interactive component, for example, a snowflake falling animation may be displayed above the interactive component, and the snowflakes may accumulate into snow when falling on the interactive component, and a promotion object may also be displayed in the interactive component, for example, "YY down jacket" may be displayed, as shown in FIG. 3. If the weather type of "XX region" is cloudy, on the one hand, the display color of the interactive component may be changed from the initial display color to a color in a cyan tone, for example, to navy blue, and on the other hand, an effect may be displayed in the interactive component and/or at a preset position around the interactive component, for example, a cloud effect may be displayed above the interactive component, and a promotion object may also be displayed in the interactive component, for example, "music headset" may be displayed, as shown in FIG. 4.

If the weather level of "XX region" is light snow, on the one hand, the display color of the interactive component may be changed from the initial display color to a relative light color in the cold tone, for example, to light blue, and on the other hand, an effect may be displayed in the interactive component and/or at a preset position around the interactive component, for example, a relatively small number of snowflakes may be displayed falling above the interactive component. If the weather level of "XX region" is heavy snow, on the one hand, the display color of the interactive component may be changed from the initial display color to a relative dark color in the cold tone, for example, to dark blue, and on the other hand, an effect may be displayed in the interactive component and/or at a preset position around the interactive component, for example, a relatively large number of snowflakes may be displayed falling above the interactive component.

With the above technical solution, the target weather information and the interactive component may be displayed when the weather information search is performed on the search page. Since the interactive component may be used for displaying the promotional information and/or accessing the landing page associated with the promotional information, when the weather information search is performed, on the one hand, the diversity of search results may be enriched, and on the other hand, an interactive function may be provided through the interactive component, thereby increasing the interaction experience of the user. In addition, since the display style of the interactive component is different when the target weather information is different, not only the display style of the interactive component may be enriched and the browsing experience of the user may be improved, but also the attention of the user may be attracted, so that the user may quickly notice the interactive component, and the interaction experience of the user may be further increased.

In order to facilitate the understanding of the content display method provided by the present disclosure, the possible implementations in the present disclosure are described below.

In a possible implementation, displaying target weather information and an interactive component in response to a search operation for weather information in the search page may include:

displaying first weather indicator information and a first interactive component in response to the search operation for the weather information in the search page; and displaying second weather indicator information and a second interactive component in response to a switch operation of switching from a first weather indicator to a second weather indicator, where the first weather indicator information is different from the second weather indicator information, and a display style of the second interactive component is different from a display style of the first interactive component.

In this embodiment, the first weather indicator may be a weather indicator displayed by default on the search page, may be a weather indicator selected by the user when the user exited after viewing the weather information last time, and may also be other weather indicator, which is not limited in the embodiments of the present disclosure.

In this embodiment, the switch operation of switching from the first weather indicator to the second weather indicator may be: displaying multiple weather indicators on the display page, and switching from the first weather indicator to the second weather indicator by triggering the second weather indicator among the multiple weather indicators; and may also be: displaying multiple weather indicators on the display page, and the user swiping the display page to display the second weather indicator information to implement switching from the first weather indicator to the second weather indicator; certainly, the switch may also be performed by other means, which is not limited in the embodiments of the present disclosure.

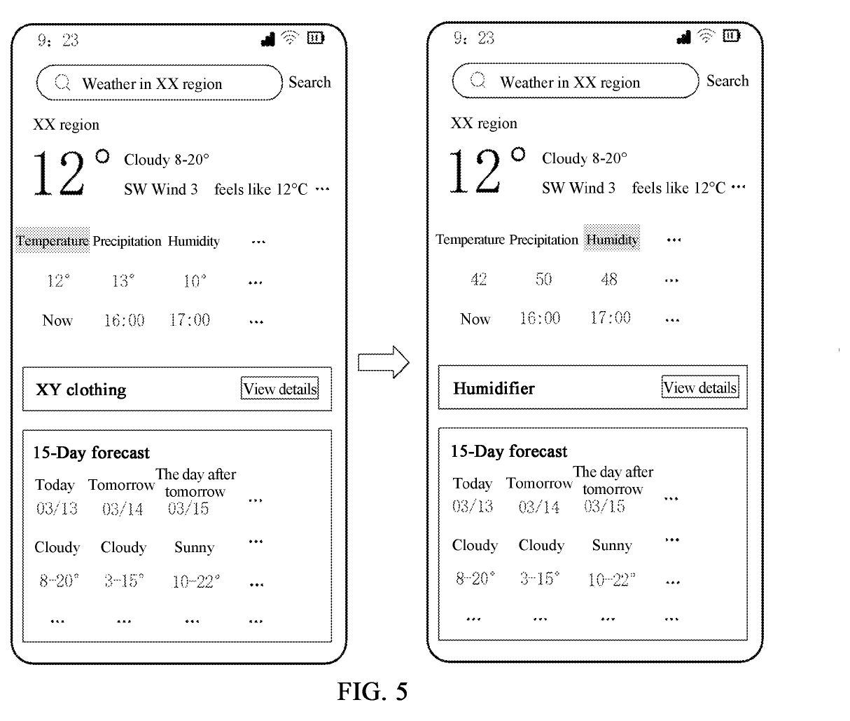

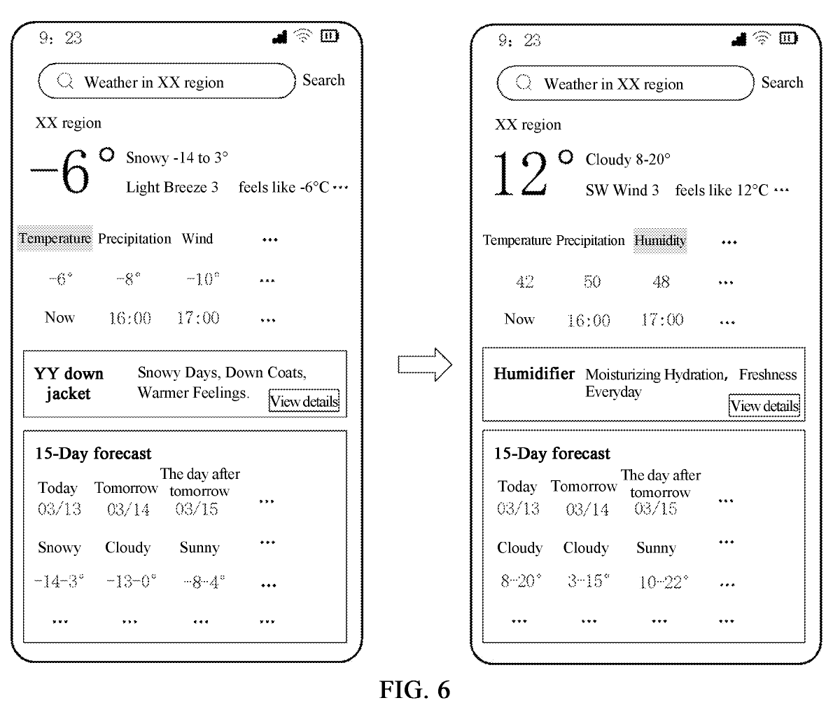

Exemplarily, still referring to the above example, when the target search term is "weather in XX region", the weather information about "XX region" under a temperature indicator and the interactive component may be displayed, and the promotion object "XY clothing" may be displayed in the interactive component. When the user triggers a humidity indicator through an operation such as clicking, the weather information about "XX region" under the humidity indicator and the interactive component may be displayed, and the promotion object "humidifier" may be displayed in the interactive component, as shown in FIG. 5.

With the above method, the interactive components with different display styles may be displayed under different weather indicators. On the one hand, the display styles of the interactive component may be enriched, and the browsing experience of the user may be improved; on the other hand, the attention of the user may be attracted by the interactive components with different display styles, so that the user may quickly notice the interactive component, and the interaction experience of the user may be further increased; in addition, the display style of the interactive component may be more in line with the weather indicator, thereby increasing the interaction interest of the user and further improving the user experience.

In a possible implementation, a first copy content for promoting a first object is displayed in the first interactive component, and the first object is associated with the first weather indicator information; and a second copy content for promoting a second object is displayed in the second interactive component, and the second object is associated with the second weather indicator information.

In this embodiment, the copy content may be determined according to the actual situation, which is not limited in the embodiments of the present disclosure. Exemplarily, the copy content may be at least one of an advertising copy, a brand slogan, selling point information, discount information, a brand logo, and a product picture of the promotion object. When the copy content is the advertising copy, a language model may be used to generate, according to the weather information and the promotion object, the advertising copy that may reflect both the weather characteristics and the brand concept, so that the copy content may be in line with the weather information and the brand concept, thereby enhancing the promotion effect of the promotion object. Exemplarily, when the weather indicator is the temperature indicator, the promotion object may be "YY down jacket", and the advertising copy may be: Snowy Days, Down Coats, Warmer Feelings. When the weather indicator is the humidity indicator, the promotion object may be a "humidifier", and the advertising copy may be: Moisturizing Hydration, Freshness Every day, as shown in FIG. 6.

In a possible implementation, in order to further enrich the content display of the search result, a background image may also be displayed, and the target weather information and the interactive component may be displayed in the background image. Meanwhile, in order to further improve the promotion effect of the promotion object, the background image may be an image associated with the promotion object displayed in the interactive component, such as a brand promotional cover, a brand logo or a product picture, etc.

With the above method, the copy content for promoting the promotion object may be displayed in the interactive component, and the promotion object is associated with the weather indicator information. Therefore, on the one hand, the diversity of the search result may be further enriched, and on the other hand, the copy content may be matched with the weather indicator information, thereby increasing the interaction interest of the user and further improving the user experience and the promotion effect of the promotion object.

In a possible implementation, the target weather information may include multiple weather information items within a preset time period, the multiple weather information items correspond to a same weather type, and the multiple weather information items under the weather type correspond to different weather levels respectively, and the display style of the interactive component is used to represent a change in the weather level corresponding to the multiple weather information items respectively.

In this embodiment, the preset time period may be different time intervals in the same day, and may also be actual intervals across different dates, which is not limited in the embodiments of the present disclosure.

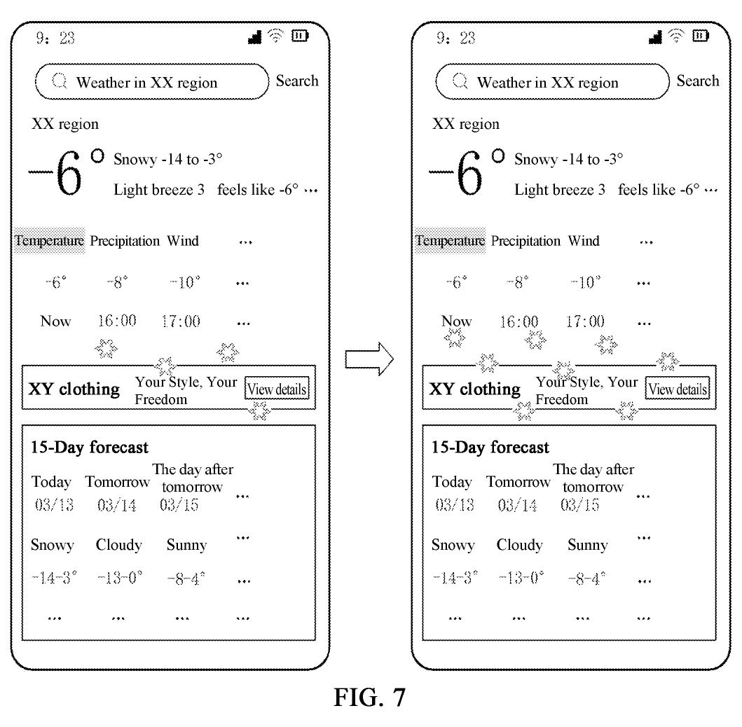

Exemplarily, still referring to the above example, when the target search term is "weather in XX region", the weather information about "XX region" and the interactive component may be displayed. If the weather information about "XX region" includes the weather information at the current moment, the weather information at 16:00, and the weather information at 17:00, where the weather type at the current moment is snowy and the weather level is light snow, the weather type at 16:00 is snowy and the weather level is moderate snow, and the weather type at 17:00 is snowy and the weather level is heavy snow, the display style of the interactive component may be used to represent the change in the weather level from the current moment to 17:00. For example, a snowflake falling effect may be displayed in the interactive component, and the number of snowflakes in the snowflake falling effect may gradually increase, as shown in FIG. 7.

With the above method, the change in the weather level corresponding to the multiple weather information items respectively may be represented by the display style of the interactive component, so that the change in the weather level may be quickly and intuitively known through the display style of the interactive component, and the user experience may be further provided.

In a possible implementation, a third promotion object and a third copy content associated with the third promotion object are displayed in the interactive component, and accordingly, the content display method may further include:

playing hidden special content associated with the third promotion object in response to a display duration of the third promotion object and/or the third copy content reaching a preset duration; and updating and displaying the third copy content as a fourth copy content associated with the third promotion object in response to playback of the hidden special content satisfying a preset condition, where the fourth copy content is different from the third copy content.

In this embodiment, the third copy content and the fourth copy content may be determined according to the actual situation, which is not limited in the embodiments of the present disclosure. Exemplarily, the third copy content may be brand information of the promotion object, such as an advertising copy, a brand slogan, or a brand logo, etc. The fourth copy content may be sales information of the promotion object, such as product information, contact information, store information, selling point information, or discount information, etc.

In this embodiment, the playback of the hidden special content satisfying the preset condition may mean that a playback duration of the hidden special content reaches a preset playback duration, may also mean that the playback of the hidden special content is completed, and may certainly mean other conditions, for example, the user manually closes the playback of the hidden special content, which is not limited in the embodiments of the present disclosure.

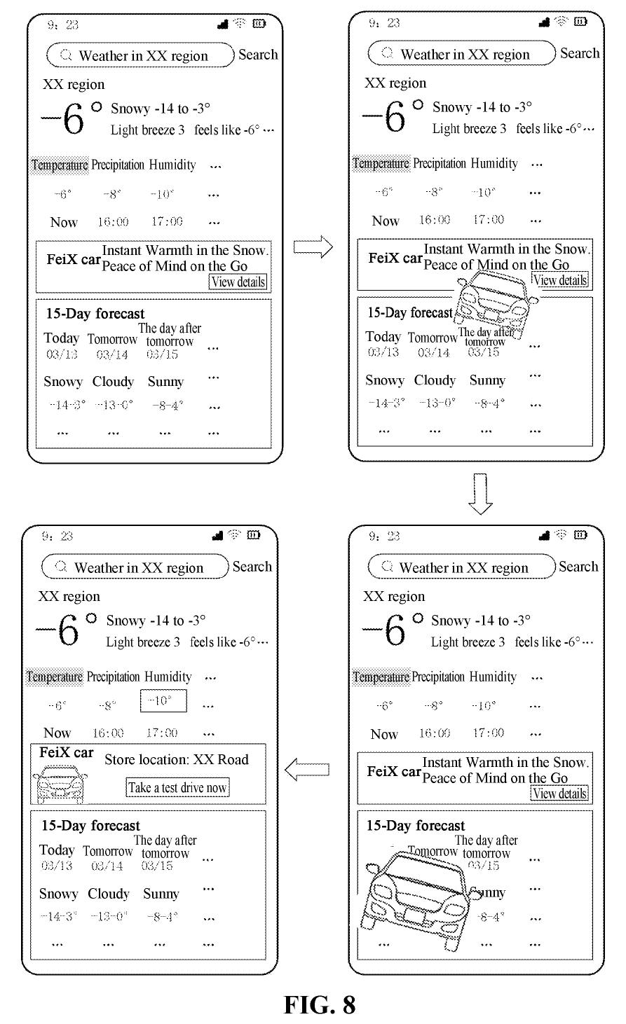

Exemplarily, when the target search term is "weather in XX region", the weather information about "XX region" and the interactive component may be displayed, and the promotion object "FeiX car" and brand information about the "FeiX car" may be displayed in the interactive component, for example, an advertising copy of the "Feixing car" may be displayed: "Instant Warmth in the Snow, Peace of Mind on the Go ". When the display duration of the advertising copy " Instant Warmth in the Snow, Peace of Mind on the Go" reaches the preset duration, for example, 1 second, the hidden special content associated with the "FeiX car" may be played, for example, a car model of the "FeiX car" may be displayed, and the car model may be moved from a first position to a second position. After the playback of the hidden special content is completed, the advertising copy "Instant Warmth in the Snow, Peace of Mind on the Go" may be updated and displayed as the sales information about the "FeiX car", for example, the store information and contact information about the "FeiX car" may be updated, as shown in FIG. 8.

With the above method, the third promotion object and the third copy content may be displayed first, and the hidden special content associated with the third promotion object may be played when the display duration of the third promotion object and/or the third copy content reaches the preset duration, and the third copy content may be updated and displayed as the fourth copy content when the playback of the hidden special content satisfies the preset condition. Therefore, when the weather information search is performed, the promotion object matching the weather information and multiple display content items associated with the promotion object may be displayed. On the one hand, the diversity of the search result may be further enriched; on the other hand, the attention of the user may be further attracted by the animation content, so that the user may quickly notice the interactive component, and the interaction experience of the user may be further increased. In addition, since the fourth copy content is different from the third copy content, the promotion object may be known more comprehensively through the fourth copy content and the third copy content, and the user experience may be further increased.

In a possible implementation, the content display method may further include:

displaying a landing page associated with the promotional information in response to a trigger operation on the promotional information in the interactive component.

With the above method, the landing page associated with the promotional information may be displayed when the interactive component is triggered, so that the way for the user to access the landing page may be simplified, and the interaction experience of the user may be further improved.

In order to further facilitate the understanding of the content display method provided by the present disclosure, the content display method provided by the present disclosure is further described below in conjunction with each step:

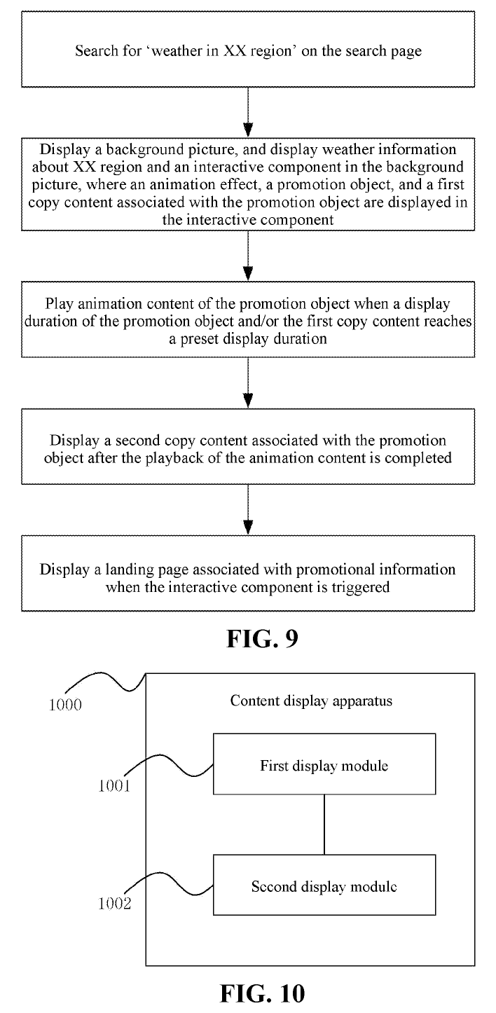

Exemplarily, as shown in FIG. 9, when the user opens the short video application, the video playback page may be displayed, and the search input box may be displayed in the upper right of the video playback page. After the user inputs "weather in XX region" in the search input box, a background image matching the current weather information about "XX region" may be displayed, and the weather information about "XX region" and an interactive component with a display style matching the current weather information about "XX region" may be displayed in the background image. Exemplarily, if the current weather in "XX region" is snowy, on the one hand, a brand promotional cover of a "YY down jacket" may be used as the background image, and on the other hand, the "YY down jacket", brand information about the "YY down jacket", and an effect matching the current weather, for example, a snowflake falling effect, may be displayed in the interactive component. If the user does not exit the weather information display page about "XX region" or does not trigger the interactive component within a preset time, animation content associated with the "YY down jacket" may be played on the weather information display page, and after the playback of the animation content is completed, the sales information about the "YY down jacket", such as discount information or store information about the "YY down jacket", may be displayed. When the user triggers the discount information, a landing page associated with the "YY down jacket" may be jumped to, so that the user may quickly receive a coupon, etc., and when the user triggers the store information, the landing page associated with the "YY down jacket" may be jumped to, so that the user may quickly obtain the store location or route information about the "YY down jacket".

With the above method, when the weather information search is performed on the search page, the target weather information and the interactive component with a display style matching the target weather information may be displayed, so that the diversity of the search result and the display style of the interactive component may be enriched, and the user experience may be improved. In addition, since the promotion object in the interactive component matches the target weather information, and the promotional information of the promotion object may be displayed in various display manners, the user may not only notice the promotion object more quickly, but also have a more comprehensive understanding of the promotion object, thereby improving the promotion effect of the promotion object.

Based on the same concept, an embodiment of the present disclosure further provides a content display apparatus. As shown in FIG. 10, the content display apparatus 1000 may include:

a first display module 1001, configured to display a search page, where the search page is used for a user to perform information search; and

a second display module 1002, configured to display target weather information and an interactive component in response to a search operation for weather information in the search page, where the interactive component is used for displaying promotional information and/or accessing a landing page associated with the promotional information, and a display style of the interactive component is different when the target weather information is different.

With the above content display apparatus 1000, the target weather information and the interactive component may be displayed when the weather information search is performed on the search page. Since the interactive component may be used for displaying the promotional information and/or accessing the landing page associated with the promotional information, when the weather information search is performed, on the one hand, the diversity of search results may be enriched, and on the other hand, an interactive function may be provided through the interactive component, thereby increasing the interaction experience of the user. In addition, since the display style of the interactive component is different when the target weather information is different, not only the display style of the interactive component may be enriched and the browsing experience of the user may be improved, but also the attention of the user may be attracted, so that the user may quickly notice the interactive component, and the interaction experience of the user may be further increased.

In a possible implementation, the display style of the interactive component is different when a weather type and/or a weather level corresponding to the target weather information are different.

In a possible implementation, the second display module 1002 may include:

a first display unit, configured to display first weather indicator information and a first interactive component in response to the search operation for the weather information in the search page; and

a second display unit, configured to display second weather indicator information and a second interactive component in response to a switch operation of switching from a first weather indicator to a second weather indicator, where the first weather indicator information is different from the second weather indicator information, and a display style of the second interactive component is different from a display style of the first interactive component.

In a possible implementation, a first copy content for promoting a first object is displayed in the first interactive component, and the first object is associated with the first weather indicator information; and a second copy content for promoting a second object is displayed in the second interactive component, and the second object is associated with the second weather indicator information.

In a possible implementation, the target weather information includes multiple weather information items within a preset time period, the multiple weather information items correspond to the same weather type, and the multiple weather information items under the weather type correspond to different weather levels respectively, and the display style of the interactive component is used to represent a change in the weather level corresponding to the multiple weather information items respectively.

In a possible implementation, a third promotion object and/or a third copy content associated with the third promotion object are displayed in the interactive component, and accordingly, the content display apparatus 1000 may further include:

a third display module, configured to play hidden special content associated with the third promotion object in response to a display duration of the third promotion object and the third copy content reaching a preset duration; and

a fourth display module, configured to update and display the third copy content as a fourth copy content associated with the third promotion object in response to playback of the hidden special content satisfying a preset condition, where the fourth copy content is different from the third copy content.

In a possible implementation, the content display apparatus 1000 may further include:

a fifth display module, configured to display a landing page associated with the promotional information in response to a trigger operation on the promotional information in the interactive component.

Based on the same concept, an embodiment of the present disclosure further provides a computer-readable medium having a computer program stored thereon, where the steps of any of the above content display methods are implemented when the program is executed by a processing apparatus.

Based on the same concept, an embodiment of the present disclosure further provides an electronic device, which may include:

a storage apparatus having a computer program stored thereon; and

a processing apparatus, configured to execute the computer program in the storage apparatus to implement the steps of any of the above content display methods.

Based on the same concept, an embodiment of the present disclosure further provides a computer program product including a computer program, where the steps of any of the above content display methods are implemented when the computer program is executed by a processor.

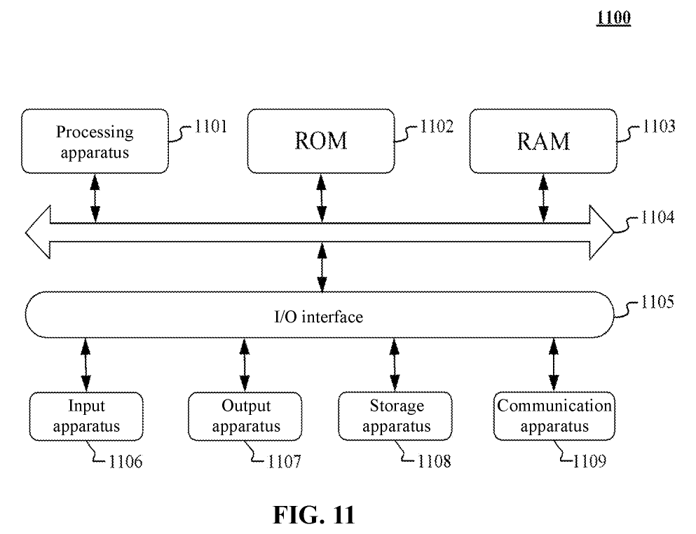

Reference is made to FIG. 11 below, which illustrates a schematic structural diagram of an electronic device 1100 suitable for implementing the embodiments of the present disclosure. The terminal device in the embodiments of the present disclosure may include, but is not limited to, mobile terminals such as a mobile phone, a laptop, a digital broadcast receiver, a personal digital assistant (PDA), a tablet computer, a portable multimedia player (PMP), and a vehicle-mounted terminal (e.g., a vehicle navigation terminal), and fixed terminals such as a digital TV and a desktop computer. The electronic device shown in FIG. 11 is only an example, and should not impose any limitation to the function and scope of use of the embodiments of the present disclosure.

As shown in FIG. 11, the electronic device 1100 may include a processing apparatus (such as a central processing unit, and a graphics processing unit) 1101, which may perform various appropriate actions and processing according to a program stored in a read-only memory (ROM) 1102 or a program loaded from a storage apparatus 1108 into a random access memory (RAM) 1103. In the RAM 1103, various programs and data required for operations of the electronic device 1100 are also stored. The processing apparatus 1101, the ROM 1102, and the RAM 1103 are connected to each other through a bus 1104. An input/output (I/O) interface 1105 is also connected to the bus 1104.

Usually, the following apparatuses may be connected to the I/O interface 1105: an input apparatus 1106 including, for example, a touch screen, a touchpad, a keyboard, a mouse, a camera, a microphone, an accelerometer, and a gyroscope; an output apparatus 1107 including, for example, a liquid crystal display (LCD), a speaker, and a vibrator; the storage apparatus 1108 including, for example, a magnetic tape and a hard disk; and a communication apparatus 1109. The communication apparatus 1109 may allow the electronic device 1100 to perform wireless or wired communication with other devices to exchange data. Although FIG. 11 shows the electronic device 1100 having various apparatuses, it should be understood that it is not required to implement or have all the apparatuses shown. Alternatively, more or fewer apparatuses may be implemented or provided.

In particular, according to the embodiments of the present disclosure, the process described above with reference to the flowchart may be implemented as a computer software program. For example, the embodiments of the present disclosure include a computer program product, which includes a computer program carried by a non-transitory computer-readable medium, and the computer program contains program code for performing the method shown in the flowchart. In such an embodiment, the computer program may be downloaded and installed from a network via the communication apparatus 1109, or installed from the storage apparatus 1108, or installed from the ROM 1102. When the computer program is executed by the processing apparatus 1101, the above-mentioned functions defined in the method of the embodiments of the present disclosure are executed.

It should be noted that the above computer-readable medium in the present disclosure may be a computer-readable signal medium, a computer-readable storage medium, or any combination of the two. The computer-readable storage medium may be, for example, but not limited to, an electrical, magnetic, optical, electromagnetic, infrared, or semiconductor system, apparatus, or device, or any combination of the above. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus, or device. In the present disclosure, the computer-readable signal medium may include a data signal propagated in a baseband or as a part of a carrier wave, and computer-readable program code is carried in the data signal. The data signal propagated in this manner may take various forms, including but not limited to an electromagnetic signal, an optical signal, or any suitable combination of the above. The computer-readable signal medium may also be any computer-readable medium other than the computer-readable storage medium, and the computer-readable signal medium may send, propagate, or transmit a program used by or in combination with an instruction execution system, apparatus, or device. The program code contained on the computer-readable medium may be transmitted in any suitable medium, including but not limited to: a wire, an optical cable, a radio frequency (RF), etc., or any suitable combination of the above.

In some implementations, any currently known or future developed network protocol such as the hypertext transfer protocol (HTTP) may be used for communication, and digital data communication (for example, a communication network) of any form or medium may be interconnected. Examples of the communication network include a local area network ("LAN"), a wide area network ("WAN"), an internet (for example, the Internet), and a peer-to-peer network (for example, an ad hoc network), as well as any network currently known or to be developed in the future.

The above computer-readable medium may be included in the above electronic device; or it may exist alone without being assembled into the electronic device.

The above computer-readable medium carries one or more programs, and when the one or more programs are executed by the electronic device, the electronic device is caused to: display a search page, where the search page is used for a user to perform information search; and display target weather information and an interactive component in response to a search operation for weather information in the search page, where the interactive component is used for displaying promotional information and/or accessing a landing page associated with the promotional information, and a display style of the interactive component is different when the target weather information is different.

The computer program code for performing the operations of the present disclosure may be written in one or more programming languages or a combination thereof, where the one or more programming languages include, but are not limited to, object-oriented programming languages such as Java, Smalltalk, and C++, and further include conventional procedural programming languages such as "C" language or similar programming languages. The program code may be executed entirely on a computer of a user, partly executed on a computer of a user, executed as an independent software package, partly executed on a computer of a user and partly executed on a remote computer, or entirely executed on a remote computer or a server. In the case of involving a remote computer, the remote computer may be connected to a computer of a user through any kind of network, including a local area network (LAN) or a wide area network (WAN), or it may be connected to an external computer (for example, connected via the Internet using an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, which contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The involved modules described in the embodiments of the present disclosure may be implemented by software, and may also be implemented by hardware. The name of a module does not constitute a limitation on the module itself under certain circumstances.

The functions described above herein may be at least partially performed by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may contain or store a program to be used by or in combination with an instruction execution system, apparatus, or device. The machine-readable medium may be a machine-readable signal medium or a machine-readable storage medium. The machine-readable medium may include, but is not limited to, an electrical, magnetic, optical, electromagnetic, infrared, or semiconductor system, apparatus, or device, or any suitable combination of the above. More specific examples of the machine-readable storage medium may include an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

The above description is only the illustrations of the preferred embodiments of the present disclosure and applied technical principles. Those skilled in the art should understand that the disclosure scope involved in the present disclosure is not limited to the technical solutions formed by specific combinations of the above technical features, and should also cover other technical solutions formed by any combination of the above technical features or equivalent features thereof without departing from the above disclosure concept. For example, the above features and the technical features provided in the present disclosure (but not limited to) with similar functions may be used interchangeably to form a technical solution.

In addition, although operations are depicted in a specific order, this should not be construed as requiring the operations to be performed in the specific order shown or in a sequential order. Under certain circumstances, multitasking and parallel processing may be beneficial. Similarly, although several specific implementation details are included in the above discussions, these should not be construed as limiting the scope of the present disclosure. Certain features described in the context of separate embodiments may also be implemented in a single embodiment in combination. On the contrary, various features described in the context of a single embodiment may also be implemented in multiple embodiments individually or in any suitable sub-combination.

Although the present subject matter has been described in a language specific to structural features and/or logical actions of the method, it should be understood that the subject matter defined in the appended claims is not necessarily limited to the specific features or actions described above. On the contrary, the specific features and actions described above are only exemplary forms for implementing the claims. Regarding the apparatus in the above embodiments, the specific manner in which each module performs an operation has been described in detail in the embodiments relating to the method, and will not be detailed herein.

I/We claim:

1. A content display method, comprising:
displaying a search page, wherein the search page is configured to enable a user to perform information search; and
displaying, in response to a search operation for weather information in the search page, first weather information and an interactive component, wherein the interactive component is configured to display promotional information and/or access a landing page associated with the promotional information, and a display style of the interactive component is different in response to the first weather information being different.

2. The content display method of claim 1, wherein the display style of the interactive component is different in response to a weather type and/or a weather level corresponding to the first weather information being different.

3. The content display method of claim 1, wherein displaying, in response to the search operation for the weather information in the search page, the first weather information and the interactive component comprises:
displaying, in response to the search operation for the weather information in the search page, first weather indicator information and a first interactive component; and
displaying, in response to a switch operation of switching from a first weather indicator to a second weather indicator, second weather indicator information and a second interactive component, wherein the first weather indicator information is different from the second weather indicator information, and a display style of the second interactive component is different from a display style of the first interactive component.

4. The content display method of claim 3, wherein a first copy content for promoting a first object is displayed in the first interactive component, and the first object is associated with the first weather indicator information; and
a second copy content for promoting a second object is displayed in the second interactive component, and the second object is associated with the second weather indicator information.

5. The content display method of claim 1, wherein the first weather information comprises multiple weather information items within a preset time period, the multiple weather information items correspond to the same weather type, and the multiple weather information items under the weather type correspond to different weather levels respectively, and the display style of the interactive component is configured to represent a change in the weather level corresponding to the multiple weather information items respectively.

6. The content display method of claim 1, wherein a third promotion object and/or a third copy content associated with the third promotion object are displayed in the interactive component, and the content display method further comprises:
playing, in response to a display duration of the third promotion object and/or the third copy content satisfying a preset duration, hidden special content associated with the third promotion object; and
updating and displaying, in response to playback of the hidden special content satisfying a preset condition, the third copy content as a fourth copy content associated with the third promotion object, wherein the fourth copy content is different from the third copy content.

7. The content display method of claim 1, further comprising:
displaying, in response to a trigger operation on the promotional information in the interactive component, the landing page associated with the promotional information.

8. A non-transitory computer-readable medium having a computer program stored thereon, wherein the computer program, when executed by a processor, causes the processor to:
display a search page, wherein the search page is configured to enable a user to perform information search; and
display, in response to a search operation for weather information in the search page, first weather information and an interactive component, wherein the interactive component is configured to display promotional information and/or access a landing page associated with the promotional information, and a display style of the interactive component is different in response to the first weather information being different.

9. The non-transitory computer-readable medium according to claim 8, wherein the display style of the interactive component is different in response to a weather type and/or a weather level corresponding to the first weather information being different.

10. The non-transitory computer-readable medium according to claim 8, wherein the computer program causing the processor to display, in response to the search operation for the weather information in the search page, the first weather information and the interactive component further causes the processor to:
display, in response to the search operation for the weather information in the search page, first weather indicator information and a first interactive component; and
display, in response to a switch operation of switching from a first weather indicator to a second weather indicator, second weather indicator information and a second interactive component, wherein the first weather indicator information is different from the second weather indicator information, and a display style of the second interactive component is different from a display style of the first interactive component.

11. The non-transitory computer-readable medium according to claim 10, wherein a first copy content for promoting a first object is displayed in the first interactive component, and the first object is associated with the first weather indicator information; and
a second copy content for promoting a second object is displayed in the second interactive component, and the second object is associated with the second weather indicator information.

12. The non-transitory computer-readable medium according to claim 8, wherein the first weather information comprises multiple weather information items within a preset time period, the multiple weather information items correspond to the same weather type, and the multiple weather information items under the weather type correspond to different weather levels respectively, and the display style of the interactive component is configured to represent a change in the weather level corresponding to the multiple weather information items respectively.

13. The non-transitory computer-readable medium according to claim 8, wherein a third promotion object and/or a third copy content associated with the third promotion object are displayed in the interactive component, and the computer program further causes the processor to:
play, in response to a display duration of the third promotion object and/or the third copy content satisfying a preset duration, hidden special content associated with the third promotion object; and
update and display, in response to playback of the hidden special content satisfying a preset condition, the third copy content as a fourth copy content associated with the third promotion object, wherein the fourth copy content is different from the third copy content.

14. The non-transitory computer-readable medium according to claim 8, wherein the computer program further causes the processor to:
display, in response to a trigger operation on the promotional information in the interactive component, the landing page associated with the promotional information.

15. An electronic device, comprising:
at least one memory having a computer program stored thereon; and
at least one processor, configured to execute the computer program in the at least one memory, causing the electronic device to:
display a search page, wherein the search page is configured to enable a user to perform information search; and
display, in response to a search operation for weather information in the search page, first weather information and an interactive component, wherein the interactive component is configured to display promotional information and/or access a landing page associated with the promotional information, and a display style of the interactive component is different in response to the first weather information being different.

16. The electronic device according to claim 15, wherein the display style of the interactive component is different in response to a weather type and/or a weather level corresponding to the first weather information being different.

17. The electronic device according to claim 15, wherein the at least one processor causing the electronic device to display, in response to the search operation for the weather information in the search page, the first weather information and the interactive component further causes the electronic device to:
display, in response to the search operation for the weather information in the search page, first weather indicator information and a first interactive component; and
display, in response to a switch operation of switching from a first weather indicator to a second weather indicator, second weather indicator information and a second interactive component, wherein the first weather indicator information is different from the second weather indicator information, and a display style of the second interactive component is different from a display style of the first interactive component.

18. The electronic device according to claim 17, wherein a first copy content for promoting a first object is displayed in the first interactive component, and the first object is associated with the first weather indicator information; and
a second copy content for promoting a second object is displayed in the second interactive component, and the second object is associated with the second weather indicator information.

19. The electronic device according to claim 15, wherein the first weather information comprises multiple weather information items within a preset time period, the multiple weather information items correspond to the same weather type, and the multiple weather information items under the weather type correspond to different weather levels respectively, and the display style of the interactive component is configured to represent a change in the weather level corresponding to the multiple weather information items respectively.

20. The electronic device according to claim 15, wherein a third promotion object and/or a third copy content associated with the third promotion object are displayed in the interactive component, and the at least one processor further causes the electronic device to:
play, in response to a display duration of the third promotion object and/or the third copy content satisfying a preset duration, hidden special content associated with the third promotion object; and
update and display, in response to playback of the hidden special content satisfying a preset condition, the third copy content as a fourth copy content associated with the third promotion object, wherein the fourth copy content is different from the third copy content.
